(19) United States
(12) Patent Application Publication
(10) Pub. No.: US 2007/0248443 A1
(43) Pub. Date: Oct. 25, 2007

(54) APPARATUS AND METHOD FOR SKINNING GAME

(76) Inventor: Raymond C. Stucks, Leveland, TX (US)

Correspondence Address: CONLEY ROSE, P.C.;David A. Rose, P. O. BOX 3267, HOUSTON, TX, 77253-3267, US

(21) Appl. No.: 11/683,760

(22) Filed: Mar. 8, 2007

Related U.S. Application Data
(60) Provisional application No. 60/793,354, filed on Apr. 20, 2006.

(51) Int. Cl. B60P 9/00

(52) U.S. Cl. 414/462

(57) ABSTRACT

An apparatus and method for skinning game. At least some of the illustrative embodiments are apparatuses comprising a member configured to couple to a vehicle receiver hitch, a main support assembly comprising a game support projection (the main support assembly coupled to the member), a pulley system coupled to the main support assembly, and a cable operatively coupled to the pulley system.

### CROSS-REFERENCE TO RELATED APPLICATIONS

This specification claims the benefit of the provisional application Ser. No. 60/793,354 filed Apr. 20, 2006, titled, “Apparatus for Skinning Deer,” which application is incorporated by reference herein as if reproduced in full below.

### BACKGROUND

Skinning of game such as deer and hogs is a task undertaken by hunters every year. It is also a task where hunters often look for and would appreciate a simplified process. A number of methods are currently employed to skin deer and other game. The most common are improvised methods such as hanging a deer to a tree or other secure location, making proper cuts in the hide, and peeling the skin back by hand. In some cases, hunters tie one end of a rope to the deer skin and the other end of the rope to a bumper or trailer hitch of a vehicle, and then slowly drive away to pull the skin off the deer.

Such methods have been used successfully in the field by hunters, but they may also be painstaking, time-consuming, and inefficient. Furthermore, finding a secure location to hang a deer may be difficult at times and the proper equipment to employ such methods may not always be readily available.

### SUMMARY

The problems noted above are addressed in large part by an apparatus and method for skinning game. At least some of the illustrative embodiments are apparatuses comprising a member configured to couple to a vehicle receiver hitch, a main support assembly comprising a game support projection (the main support assembly coupled to the member), a pulley system coupled to the main support assembly, and a cable operatively coupled to the pulley system.

Other illustrative embodiments are methods comprising coupling a game skinning apparatus to a vehicle receiver hitch, suspending an animal from the game skinning apparatus, and skinning the animal by actuating a winch assembly operatively coupled to a second end of a cable.

### BRIEF DESCRIPTION OF THE DRAWINGS

For a detailed description of various embodiments of the invention, reference will now be made to the accompanying drawings in which:

FIG. 1A illustrates an apparatus in accordance with various embodiments;

FIG. 1B illustrates a portion of an apparatus in accordance with various embodiments;

FIG. 2A illustrates a front view of a hoisting bar in accordance with various embodiments;

FIG. 2B illustrates a front view of a hoisting bar in accordance with alternative embodiments;

FIG. 3A illustrates an end view of a hoisting bar in accordance with various embodiments;

FIG. 3B illustrates an end view of a hoisting bar in accordance with alternative embodiments;

FIG. 3C illustrates an end view of a hoisting bar in accordance with other alternative embodiments;

FIG. 4A illustrates an end view of a hoisting bar in an operative configuration in accordance with various embodiments;

FIG. 4B illustrates an end view of a hoisting bar in an operative configuration in accordance with alternative embodiments;

FIG. 4C illustrates a top view of a game support projection in accordance with various embodiments;

FIG. 4D illustrates a perspective view of a hoisting bar in an operative configuration in accordance with various embodiments; and

FIG. 5 illustrates a flow diagram in accordance with various embodiments.

### NOTATION AND NOMENCLATURE

Certain terms are used throughout the following description and claims to refer to particular system components. This document does not intend to distinguish between components that differ in name but not function.

In the following discussion and in the claims, the term “comprises” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections.

### DETAILED DESCRIPTION OF THE PREFERRED EMBODIMENTS

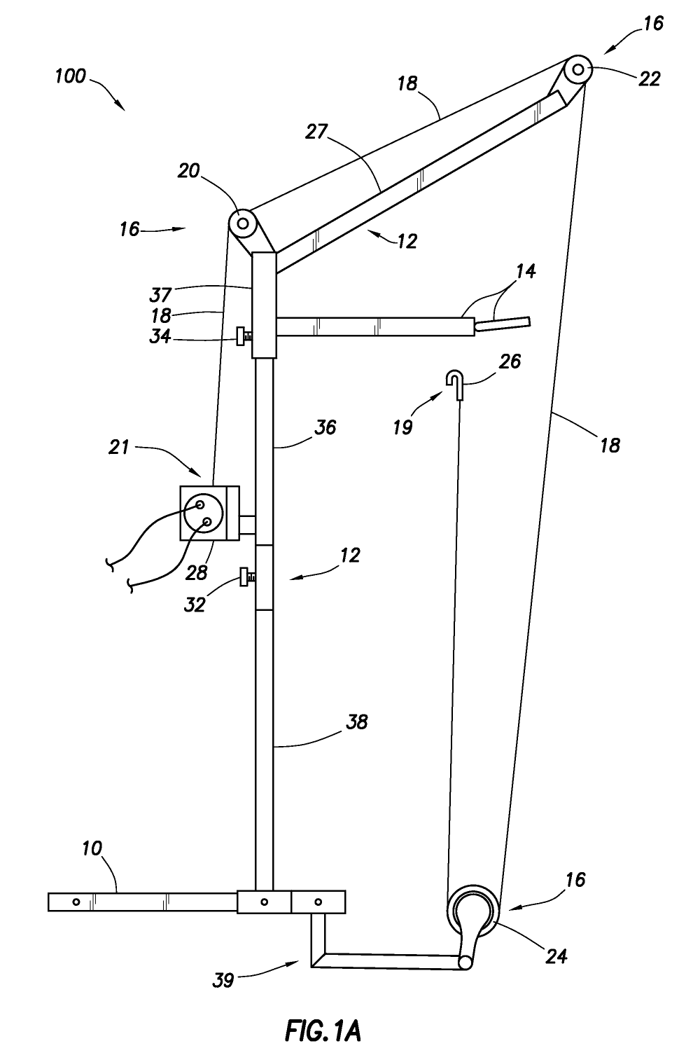

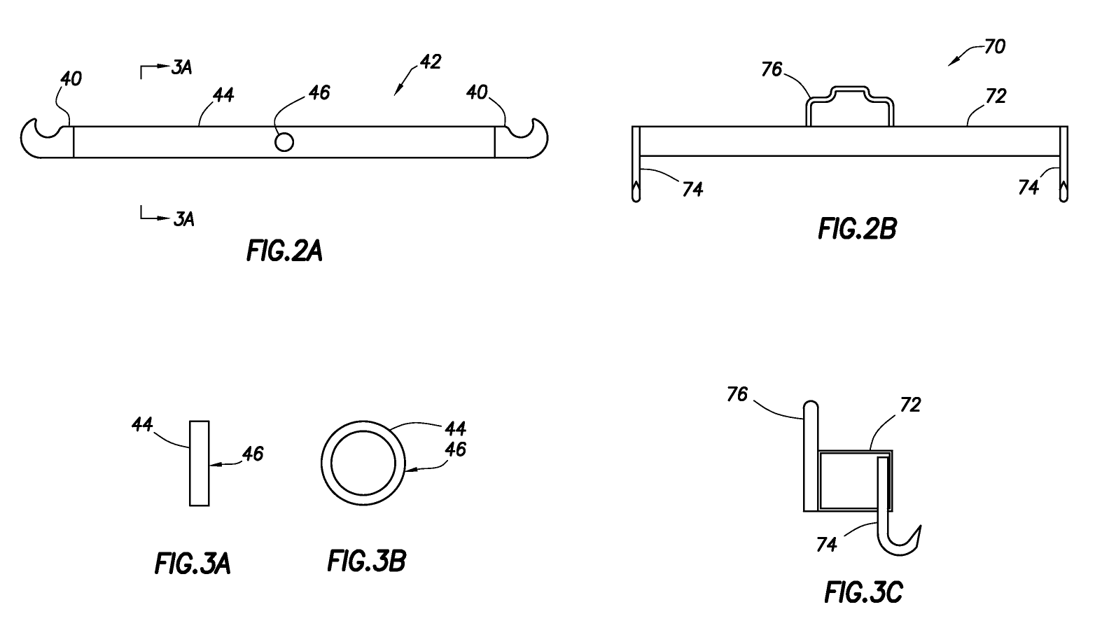

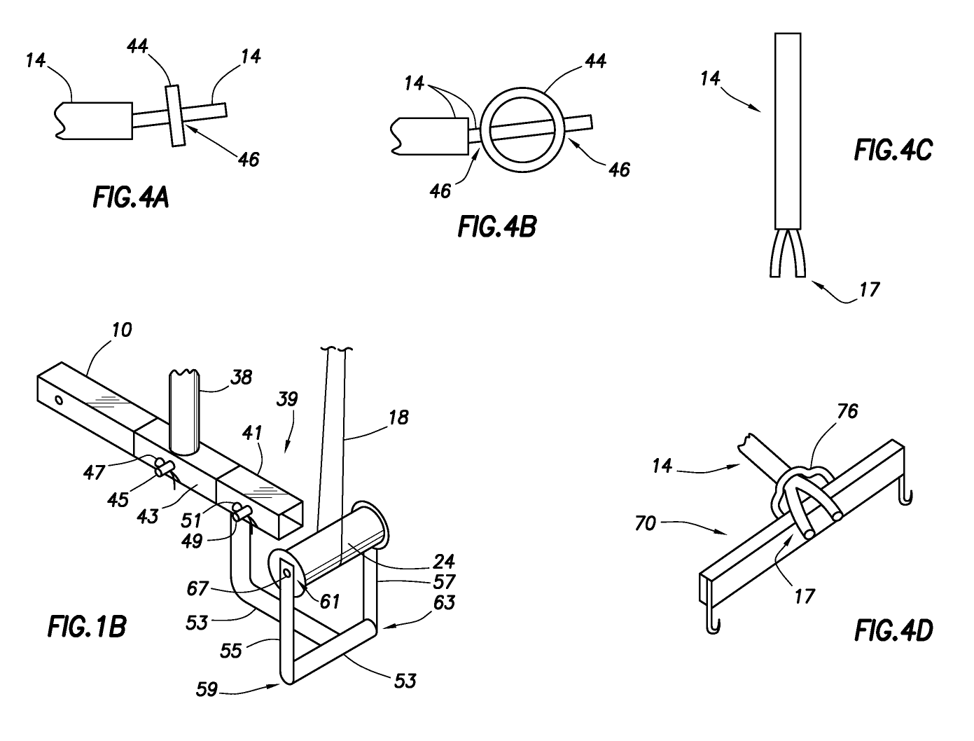

FIG. 1A illustrates an apparatus 100 for skinning game. The apparatus 100 comprises a member 10 that is configured to couple to a vehicle receiver hitch. In some embodiments, the member 10 is configured to couple to a 2-inch vehicle receiver hitch, but other sizes may be equivalently used. A main support assembly 12 is operatively coupled to the member 10, and comprises a game support projection 14 used for holding game such as deer and hogs. Furthermore, the main support assembly 12 comprises individual members detachably and telescopically coupled for ease of assembly, moving, and storage, and for apparatus customization based on the type of vehicle or the type of animal. In particular, a first upper member 36 is detachably and telescopically coupled to a first lower member 38. In some embodiments, a set screw 32 is used to couple the first upper member 36 to the first lower member 38. For example, in embodiments wherein the first lower member 38 is coupled within the first upper member 36, the set screw 32 may pass through a threaded hole in the first upper member 36, and the set screw 32 is then tightened against the first lower member 38 to prevent relative motion between the two members. In other embodiments wherein the first upper member 36 is coupled within the first lower member 3 8, the set screw 32 may pass through a threaded hole in the first lower member 3 8, and the set screw 32 is then tightened against the first upper member 36. The first upper member 36 is also detachably and telescopically coupled to a second upper member 37. The game support projection 14 is coupled to and extends in a normal direction from the second upper member 37. In some exemplary embodiments, a set screw 34 is used to couple the second upper member 37 to the first upper member 36. For example, the set screw 34 may pass through a threaded hole in the second upper member 37, and the set screw 34 is then tightened against the first upper member 36 to prevent relative motion between the two members.

In other embodiments, the first upper member 36 and the first lower member 38, or the first upper member 36 and the second upper member 37, may be coupled by an alternative fastening device. The alternative fastening device may comprise, for example, a threaded nut and a threaded bolt. The illustrative threaded bolt may pass through both the first upper member 36 and the first lower member 38, and the threaded nut is then tightened onto an end of the threaded bolt, thus coupling the first upper member 36 to the first lower member 38. In a similar manner, a threaded nut and a threaded bolt can be used to couple the first upper member 36 to the second upper member 37. In yet other embodiments, the alternative fastening device comprises a pin, a rivet, a ring, or a clamp, among others. A set screw or other alternative fastening device may also be used to secure the first lower member 38 to a lower portion 39 to prevent relative motion between the first lower member 38 and the lower portion 39.

In the embodiments illustrated in FIG. 1A, the apparatus 100 also comprises a pulley system 16 operatively coupled to the main support assembly 12. The pulley system 16 comprises a first upper pulley 20, a second upper pulley 22, and a lower pulley 24. The first upper pulley 20 and the second upper pulley 22 are coupled to a third upper member 27 which is coupled to the second upper member 37, and the lower pulley 24 is coupled to the lower portion 39. Moreover, a cable 18 is used in functional cooperation with the pulley system 16. The cable 18 comprises a cable, a rope, a chain or combinations thereof having a first end 19 and a second end 21, wherein the first end 19 is terminated by a hook assembly 26 and wherein the second end 21 is operatively coupled to a winch assembly 28. The hook assembly 26 may comprise a hook or tie suitable for hoisting game and for removing the skin of a deer, hog, varmint, or other type of animal. A winch assembly 28 coupled to the second end 21 may comprise a motor-driven or band-powered lifting device having a drum around which the cable, rope, or chain winds. The cable 18 may be alternatively configured with the pulley system 16 for hoisting, hauling, or skinning game.

In some exemplary embodiments, the main support assembly 12 may also be rotatable about a vertical axis, thus allowing for ease of transfer of game to a vehicle such as the bed of a truck or the back of a van or sport utility vehicle (SUV). For example, by loosening the set screw 32, the first upper member 36 may rotate while the first lower member 38 remains in a substantially fixed position. The axis of rotation may be defined for example, by a centerline of the first upper member 36 and the first lower member 38.

FIG. 1B illustrates a more detailed view of the lower portion 39 of the main support assembly 12. As shown, the second lower member 38 comprises a foot 43, and the member 10 telescopically couples through the foot 43 and is secured in place by way of a pin 45 which is held in position by a keeper 47. The lower portion 39 comprises a second lower member 41 that telescopically couples to an end of the member 10 and is secured in place by way of a pin 49 which is held in position by a keeper 51. The lower portion 39 further comprises a support assembly 53 coupled to the second lower member 41. The support assembly 53 is coupled on an end 59 to a first arm 55, and coupled on an end 63 to a second arm 57. An end 61 of the first arm 55 supports the lower pulley 24 by way of a first fastening device 67 such as a pin or rivet, and an end (not shown) of the second arm 57 supports the lower pulley 24 by way of a second fastening device (not shown). In addition, the cable 18 may be functionally coupled to the lower pulley 24.

FIG. 2A illustrates a hoisting bar 42. The hoisting bar 42 comprises a member 44 terminated on each end by a hook portion 40. In alternative embodiments, the hook portion 40 may comprise a grappling device, such as a claw or tie, among others. The member 44 also comprises a receiving portion 46 such as an eyelet configured for operation with the game support projection 14 (FIG. 1A). FIG. 2B illustrates an alternative hoisting bar 70 which comprises a member 72 terminated on each end by a hook portion 74. The hoisting bar 70 further comprises a receiving portion 76 such as a hanger which is configured for operation with the game support projection 14. FIGS. 3A and 3B show an end view of alternative embodiments of the member 44, as taken along line 3A-3A of FIG. 2A. As illustrated in FIG. 3A, the member 44 may comprise a rectangular bar. As illustrated in FIG. 3B, the member 44 may comprise a pipe. FIG. 3C illustrates an end view of the hoisting bar 70 of FIG. 2B, wherein the configuration of the member 72, the receiving portion 76, and the hook portion 74 is more clearly shown.

In FIG. 4, the member 44 of hoisting bar 42 is shown in an operational configuration with the game support projection 14. Specifically, FIG. 4A illustrates the game support projection 14 passing through the receiving portion 46 of the member 44 wherein the member 44 comprises a rectangular bar. FIG. 4B illustrates alternative embodiments in which the game support projection 14 passes through the receiving portion 46 of the member 44 wherein the member 44 comprises a pipe. FIG. 4C illustrates a top view of alternative embodiments of the game support projection 14 comprising a two-pronged hook 17. FIG. 4D illustrates the game support projection 14 in an operational configuration with the hoisting bar 70. As shown, the two-pronged hook 17 passes through the receiving portion 76 of the hoisting bar 70, thus supporting the hoisting bar 70 in a suspended manner.

In some embodiments, a hoisting bar is used to lift an animal (e.g. deer or other game) from a position on the ground to a position hanging from the apparatus 100 (FIG. 1A). When the apparatus 100 is in a hoisting configuration, the cable 18 may be in functional cooperation with the first upper pulley 20 and the second upper pulley 22 while the lower pulley 24 is unused. The configuration of the lower pulley 24, as illustrated in FIG. 1B, allows for the cable 18 to be easily disengaged from the lower pulley 24 for operation of the apparatus 100 in the hoisting configuration. In particular, the lower pulley 24 has a wide non-restrictive surface area allowing the hook assembly 26 (FIG. 1A) to be easily disengaged from the lower pulley 24. In addition, the distance between the lower pulley 24 and the second lower member 41 is such that the hook assembly 26 can be easily disengaged from the lower pulley 24 without getting trapped to a portion of the apparatus 100. The animal may be attached (e.g., by the legs) to the hook portion 40 which terminates each end of the hoisting bar 42 (or to the hook portion 74 which terminates each end of the hoisting bar 70). Thereafter, the hook assembly 26 of the cable 18 (FIGS. 1A and 1B) is coupled to the hoisting bar 42 by way of the receiving portion 46 (or to the hoisting bar 70 by way of the receiving portion 76). Upon actuation of the winch assembly 28 (FIG. 1A), the hoisting bar 42 (or the hoisting bar 70), and thus the animal is lifted upwardly from the ground. The lifting may continue until the receiving portion 46 of the hoisting bar 42 (or the receiving portion 76 of the hoisting bar 70) reaches a vertical position that is about equal to the vertical position of the game support projection 14. Thereafter, the game support projection 14 is coupled through the receiving portion 46 (or through the receiving portion 76), and the hook assembly 26 is removed from the receiving portion 46 (or from the receiving portion 76) such that the hoisting bar 42 (or the hoisting bar 70) and the animal are freely hanging from the game support projection 14 of the apparatus 100. In some embodiments the game support projection 14 is coupled through the receiving portion 46 (or through the receiving portion 76) before the hook assembly 26 is removed. In other embodiments, the game support projection 14 is coupled through the receiving portion 46 (or through the receiving portion 76) while the hook assembly 26 is simultaneously removed. For example, simultaneous removal of the hook assembly 26 may be performed in situations wherein the receiving portion 46 is not sufficiently large to accommodate both the game support projection 14 and the hook assembly 26 at the same time. In some exemplary embodiments, the pulley system 16 and cable 18 may not be needed to lift smaller, lighter weight animals. In such cases, the animal may be attached to the hoisting bar, manually lifted off the ground, and the game support projection 14 can then be coupled through the receiving portion 46 (or the receiving portion 76) such that the hoisting bar and the animal are freely hanging from the game support projection 14 of the apparatus 100. In yet other embodiments, some smaller, lighter weight animals may be lifted off the ground and directly coupled to the game support projection 14 without use of the hoisting bar.

With the animal hanging from the game support projection 14, the apparatus 100 may be used for skinning the animal. When the apparatus 100 is in a skinning configuration, the cable 18 is in functional cooperation with the first upper pulley 20, the second upper pulley 22, and the lower pulley 24, such as illustrated in FIG. 1A. The configuration of the lower pulley 24, as illustrated in FIG. 1B, allows for the cable 18 to be easily engaged to the lower pulley 24 for operation of the apparatus 100 in the skinning configuration. In some embodiments, the hook assembly 26 is attached to a portion of the animal's skin near its highest hanging position, and the winch assembly 28 is actuated such that the cable 18 and pulley system 16 pull the hook assembly 26 downward, thus peeling back the animal's skin and ultimately pulling the skin off the animal while the animal remains suspended by the hoisting bar and game support projection 14. In some exemplary embodiments, cuts may be made to the animal's skin to facilitate attachment of the hook assembly 26.

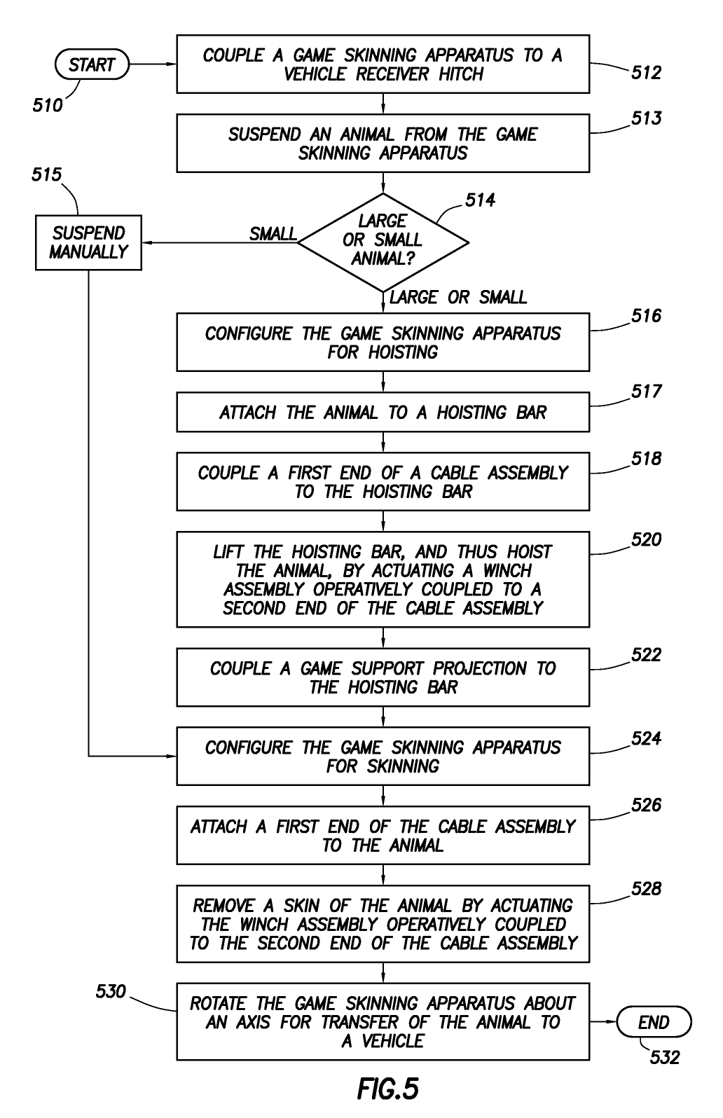

FIG. 5 illustrates a method in accordance with some embodiments. In particular, the process starts (block 510) and proceeds to coupling the game skinning apparatus 100 to a vehicle receiver hitch (block 512). An animal (e.g., deer or other game) is then suspended from the game skinning apparatus (block 513). In particular, the method used for suspending the animal may depend on the size of the animal (block 514). For smaller and/or lighter animals, the animal may be lifted and suspended manually (block 515). In particular, the smaller animals may be suspended directly from the game support projection 14 or the animal can be first attached to a hoisting bar and then suspended from the game support projection. The process would then proceed directly to placing the apparatus 100 in a skinning configuration (block 524). However, if the apparatus is used for lifting an animal, whether large or small, then the apparatus 100 is placed in a hoisting configuration (block 516). The process continues to attach an animal to the hoisting bar (block 517) by way of the hook portion 40 that terminates each end of the member 44 (or by way of the hook portion 74 that terminates each end of the member 72). Thereafter, a first end of a cable 18 is coupled to the hoisting bar (block 518). Specifically, the hook assembly 26 of the cable 18 is coupled to the hoisting bar by way of the receiving portion 46 or the receiving portion 76. The process continues to lift the hoisting bar, and thus hoist the animal, by actuating a winch assembly 28 operatively coupled to a second end of the cable 18 (block 520). In some embodiments, the lifting may continue until the receiving portion 46 (or the receiving portion 76) of the hoisting bar 42 (or the hoisting bar 70) reaches a vertical position that is about equal to the vertical position of the game support projection 14. Thereafter, the game support projection 14 is coupled through the receiving portion 46 of the hoisting bar 42 (or through the receiving portion 76 of the hoisting bar 70) (block 522). Thus, the hoisting bar and the animal may freely hang from the game support projection 14 of the apparatus 100. The apparatus 100 is then placed in a skinning configuration (block 524). The first end of the cable 18 is attached to the animal (block 526), and the skin is removed by actuating the winch assembly 28 (block 528). Specifically, the hook assembly 26 is attached to a portion of the animal's skin near its highest hanging position, and the winch assembly 28 is actuated such that the cable 18 and pulley system 16 pull the hook assembly 26 downward, thus peeling back the animal's skin. The apparatus 100 may then be rotated about an axis for transfer of the animal to a vehicle (block 530). The process then ends (block 532).

In some exemplary embodiments, at least a portion of the apparatus 100 is constructed using schedule 80 (SCH80) pipe. A pipe schedule defines a pipe wall thickness (i.e., a pipe strength); however, the actual wall thickness will vary depending on the internal diameter (i.e., nominal bore) of a given pipe. In other embodiments, the hoisting bar may also be constructed using SCH80 pipe. In yet other embodiments, portions of the apparatus 100 or the hoisting bar may be constructed using pipe having a different schedule value.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. An apparatus comprising:
a member configured to couple to a vehicle receiver hitch;
a main support assembly comprising a game support projection, the main support assembly coupled to the member;
a pulley system coupled to the main support assembly; and
a cable operatively coupled to the pulley system.

2. The apparatus according to claim 1 wherein the main support assembly comprises an upper member detachably and telescopically coupled to a lower member.

3. The apparatus according to claim 2 wherein the upper member is coupled to the lower member by a fastening device.

4. The apparatus according to claim 1 wherein the main support assembly is rotatable about an axis.

5. The apparatus according to claim 1 wherein the pulley system comprises a first upper pulley, a second upper pulley, and a lower pulley.

6. The apparatus according to claim 1 wherein the cable comprises a cable, a rope, or a chain.

7. The apparatus according to claim 1 wherein the cable comprises a first end terminated by a hook assembly and a second end operatively coupled to a winch assembly.

8. The apparatus according to claim 7 wherein the hook assembly comprises a hook or a tie used for hoisting or skinning game.

9. The apparatus according to claim 7 wherein the winch assembly comprises a motor-driven or a hand-powered lifting device having a drum around which a cable, a rope, or a chain winds.

10. The apparatus according to claim 1 wherein the cable is configured with the pulley system for one selected from the group consisting of: hoisting game; or skinning game.

11. The apparatus according to claim 1 further comprising a hoisting bar terminated on each a first end and a second end by a hook portion.

12. The apparatus according to claim 11 wherein the game support projection couples through a receiving portion of the hoisting bar.

13. A method comprising:
coupling a game skinning apparatus to a vehicle receiver hitch;
suspending an animal from the game skinning apparatus; and
skinning the animal by actuating a winch assembly operatively coupled to a second end of a cable.

14. The method according to claim 13 further comprising attaching the animal to a hoisting bar.

15. The method according to claim 14 further comprising coupling a first end of the cable to the hoisting bar.

16. The method according to claim 15 further comprising lifting the hoisting bar by actuating the winch assembly.

17. The method according to claim 13 further comprising coupling a game support projection trough a receiving portion of a hoisting bar.

18. The method according to claim 13 further comprising attaching a first end of the cable to the animal.

19. The method according to claim 18 further comprising hoisting the animal by actuating the winch assembly.

20. The method according to claim 13 further comprising rotating the game skinning apparatus about an axis for transfer of the animal to a vehicle.
